(19) United States
(12) Patent Application Publication
(10) Pub. No.: US 2010/0241820 A1
(43) Pub. Date: Sep. 23, 2010

(54) RECLAIMING STORAGE ON A THIN-PROVISIONING STORAGE DEVICE

(75) Inventors: Greg PELTS, Santa Clara, CA (US); Michael Cameron HAY, Yokohama (JP)

Correspondence Address: MATTINGLY & MALUR, P.C., 1800 DIAGONAL ROAD, SUITE 370, ALEXANDRIA, VA, 22314, US

(73) Assignee: HITACHI DATA SYSTEMS CORPORATION, Santa Clara, CA (US)

(21) Appl. No.: 12/794,302

(22) Filed: Jun. 4, 2010

Related U.S. Application Data
(63) Continuation of application No. 11/906,624, filed on Oct. 2, 2007.

(51) Int. Cl. G06F 12/00; G06F 12/02

(52) U.S. Cl. 711/170; 711/E12.001; 711/E12.002

(57) ABSTRACT

A method, medium and apparatus for managing storage in a thin-provisioning storage device. The method includes ceasing to use storage on thinly provisioned storage delivered by a thin-provisioning storage device and notifying the thin-provisioning storage device of the unused storage. The method may further include reclaiming the unused storage in response to the notification. Alternatively, the notification may include recognizing the storage being freed and communicating the recognition to the storage device. In another form, the invention is a method, medium and apparatus for managing storage in a thin-provisioning storage device. This method includes delivering thinly provisioned storage and receiving notification that part of the thinly provisioned storage is no longer in use. The method may further include reclaiming that part of the thinly provisioned storage in response to the notification. Between receiving and reclaiming, the method may wait for a time to pass.

### TECHNICAL FIELD

This invention generally relates to computer data processing systems and data storage and, more particularly, to thin provisioning and storage reclamation.

### BACKGROUND ART

FIG. 1 illustrates the architecture of a conventional computer system 1. The computer system includes a computer (or “host”) 11, a storage subsystem 12 and a communications subsystem 13. The communications subsystem 13 communicatively couples the computer 11 and the storage subsystem 12.

The storage subsystem 12 includes a pool 121 of storage that the storage subsystem 12 can allocate as the logical unit (LU) 122. Still further, the storage subsystem 12 can advertise and deliver the LU 122.

Among the properties the storage subsystem 12 advertises about the LU 122 is its size. In the most conventional computer systems, the size is the actual, fixed amount of storage from the pool 121 allocated as the LU 122. This convention is termed “fat provisioning” in the art.

In more sophisticated computer systems 1 using thin provisioning, the size property has two facets: advertised (virtual) size and delivered size. “Advertised size” is the maximum amount of storage from the pool 121 that the storage subsystem 12 would allocate on demand to the LU 122. Advertised size corresponds to the most conventional concept of “size.”

“Delivered size” is the actual, variable amount of storage from the pool 121 that the storage subsystem 12 has currently allocated to the LU 122. As an I/O consumer (typically, a host computer 11) writes data and approaches the delivered size, the storage subsystem 12 allocates more storage from the pool 121 to the LU 122, thus increasing the delivered size of the LU 122. (Typically, the advertised size remains unchanged.)

In fat provisioning, storage is allocated and dedicated to an individual I/O consumer. Where, however, an I/O consumer underutilizes the storage delivered as LU 122, a significant amount of storage can go unused.

With its schema of pooling storage and allocating it on demand, thin provisioning drives up storage usage. Thin provisioning even enables system administrators to purchase less storage in the first place.

Thin provisioning works well to allocate storage on demand. Thin provisioning, however, does not provide for deallocating or reclaiming storage.

Thus, where an I/O consumer writes data to the LU 122, the storage subsystem 12 allocates storage from the pool 121 as necessary. When the I/O consumer later frees storage, the storage from the pool 121 remains allocated but unused. Since the thin-provisioning storage subsystem 12 has no mechanism to detect unused capacity, that capacity remains unused and unavailable to other storage consumers.

Consider the administrator of an I/O consumer who runs a data classifier. The data classifier reports that many files have not been accessed, let alone modified, in years. Relying on the report, the administrator removes all of these files. The resulting spare capacity nonetheless remains dedicated to the I/O consumer.

Consider another application running on an I/O consumer. The application requires temporary space one day a month. During this time the application uses 80% of the advertised size of an LU. For the remaining twenty-nine days, however, only 1% of the advertised size is used. Nonetheless, for all times, the storage device delivers 80% of the advertised size for that I/O consumer.

Accordingly, a need exists for detecting, reclaiming and re-delivering unused storage in a thin-provisioning storage system.

These and other goals of the invention will be readily apparent to one of skill in the art on reading the background above and the description below.

### BRIEF SUMMARY OF THE INVENTION

Herein are taught a method, medium and apparatus for managing storage in a thin-provisioning storage device. The method includes ceasing to use storage on thinly provisioned storage delivered by a thin-provisioning storage device and notifying the thin-provisioning storage device of the unused storage. The method may further include reclaiming the unused storage in response to the notification. Alternatively, the notification may include recognizing the storage being freed and communicating the recognition to the storage device.

In another embodiment, the invention is a method, medium and apparatus for managing storage in a thin-provisioning storage device. This method includes delivering thinly provisioned storage and receiving notification that part of the thinly provisioned storage is no longer in use. The method may further include reclaiming that part of the thinly provisioned storage in response to the notification. Between receiving and reclaiming, the method may wait for a time to pass. While waiting, the method may receive I/O or additional notification regarding the thinly provisioned storage and, in response to the I/O or additional notification, adjust the amount of storage to reclaim.

In yet another embodiment, the invention is a method, medium and apparatus for managing storage in a thin-provisioning storage device. The method includes delivering thinly provisioned storage and then reclaiming part of the thinly provisioned storage.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF THE DRAWINGS

FIG. 1 illustrates the architecture of a conventional computer system.

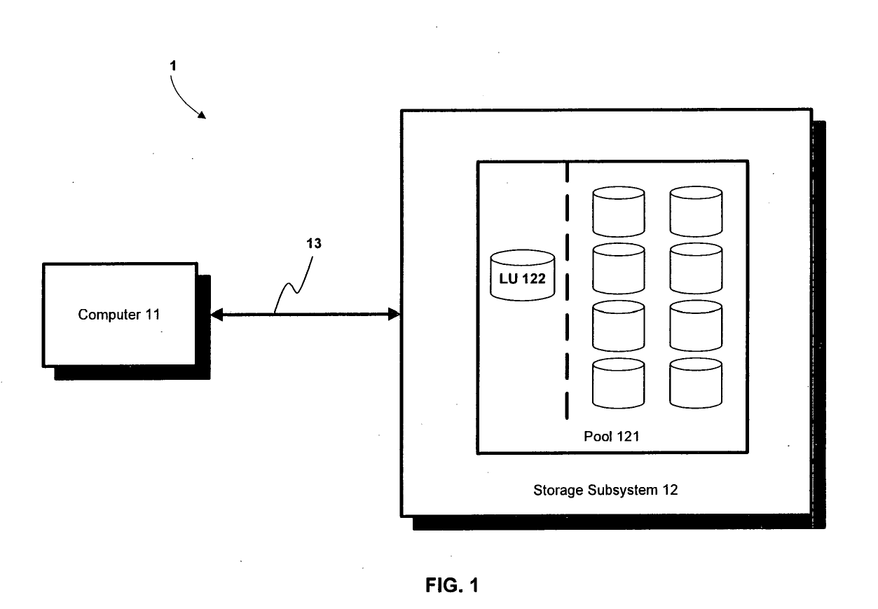

FIG. 2 illustrates a computer system according to an embodiment of the invention.

FIG. 3 illustrates the computer system of FIG. 2 in operation.

FIG. 4 illustrates the storage-subsystem method of reclaiming freed space.

FIG. 5 illustrates the method of delaying the reclamation of freed space.

### DETAILED DESCRIPTION OF THE INVENTION

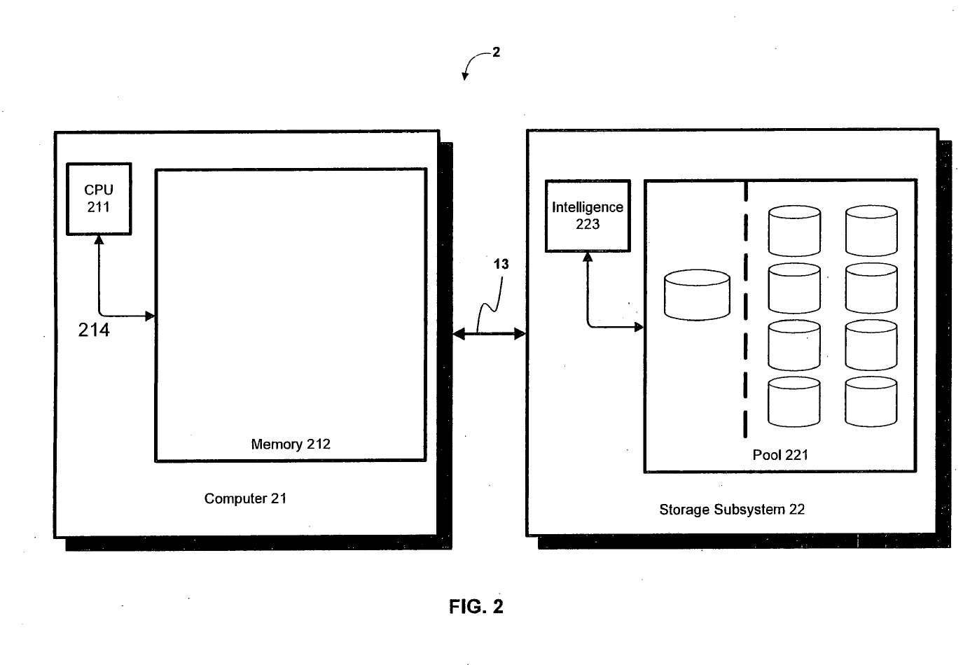

FIG. 2 illustrates a computer system 2 according to an embodiment of the invention. The computer system 2 includes a computer (host) 21, the storage subsystem 22 and the communications subsystem 13. The communications subsystem 13 communicatively couples the computer 21 and the storage subsystem 22.

The computer 21 includes a CPU 211, the memory 212, the I/O devices (not shown) and a bus 214. The bus 214 communicatively couples the other computer components.

The storage subsystem 22 is a thin-provisioning storage system modified according to the invention described herein. The storage subsystem 22 includes a pool 221 of storage. The storage subsystem 22 also includes intelligence 223 in the form of a CPU and associated programmed memory, an ASIC or the like.

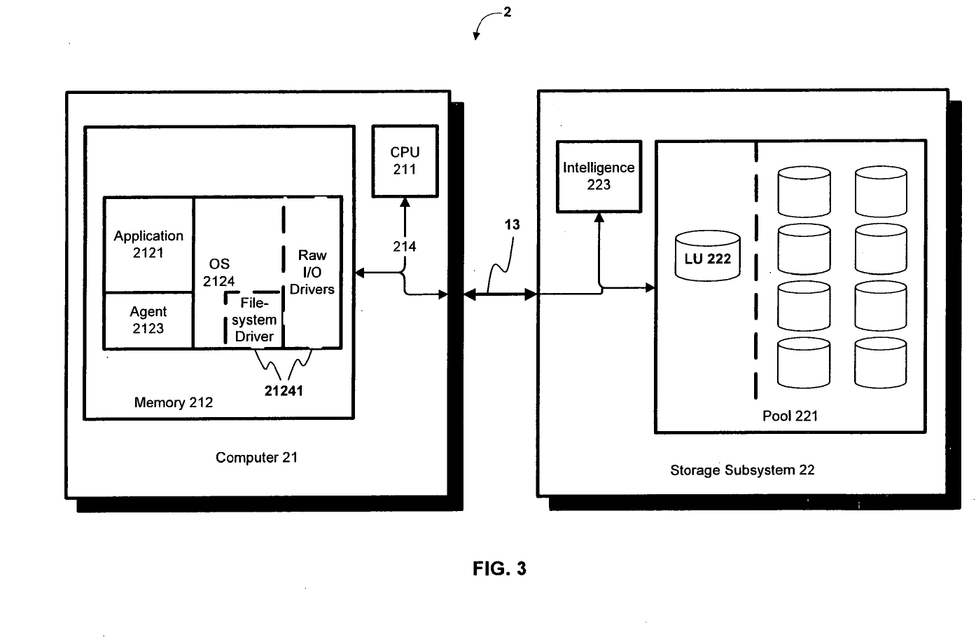

FIG. 3 illustrates the computer system 2 in operation. The memory 212 includes operating-system software 2124, as well as application software 2121 and driver software 21241. In some embodiments as described herein, the computer memory 212 includes a storage-subsystem agent (service, daemon) 2123.

The storage subsystem 22 has allocated from the pool 221 of storage a logical unit (LU) 222. The storage subsystem 22 advertises the LU 222 to the host 21.

The application 2121 has written to the LU 222. Because of previous writes, the LU's delivered size has grown from its original delivered size. The application 2121 now deletes a file. The storage subsystem 22 receives notification of the deletion and reclaims the storage previously used by the file.

In deleting the file, the application 2121 issues a command to the system library (operating-system application programmers interface) to delete the file. The system library in turn makes a request of the operating system to delete the file.

If (the data on) the LU 222 is a filesystem, then the operating system uses its knowledge of the filesystem to modify the filesystem to effect the deletion. The modification typically includes changing memory-resident copies of key filesystem data structures and then writing the modified copies to the LU 222. (This intelligence may be encapsulated in what is, in effect, a filesystem driver 21241.)

Suppose that the filesystem free space is tracked as a linked list of triplets of starting address, extent and a pointer to the next triplet. The successful insertion of a triplet of newly freed space into the linked list can trigger the notification to the storage subsystem 22 of the free space.

Where filesystem free-space blocks are tracked as clear or set bits, the clearing of bits in the filesystem driver can trigger the notification to the storage subsystem 22 of the free space.

If the operating system 2124 is accessing the LU 222 in raw mode on behalf of the application 2121, the operating system 2124 has no knowledge of the structure of the data on the LU 222. That intelligence is built into the application. The operating system 2124 translates the application-space logical addressing of the LU 222 into the device addressing necessary to accomplish I/O.

When the application 2121 receives acknowledgment that a modification of the free space of the LU 222 has succeeded, the application 2121 then invokes a kernel trap, communicating to the operating system that some storage is now free. The operating system 2124 communicates that information to the storage subsystem 22.

In one embodiment, the application 2121 signals the agent 2123 rather than the operation system 2124, and the agent 2123 traps into the OS kernel.

Where the operating system 2124 frees N extents of storage in one call, the storage subsystem 22 may receive notice of the free extents in less than N notifications—even as few as one notification.

The storage subsystem 22 thus receives from the operating system 2124 information identifying the storage that can be reclaimed—starting block addresses and respective block counts, for example. The storage subsystem 22 then reclaims it. The delivered size of the LU 222 decreases, and its advertised size remains unchanged.

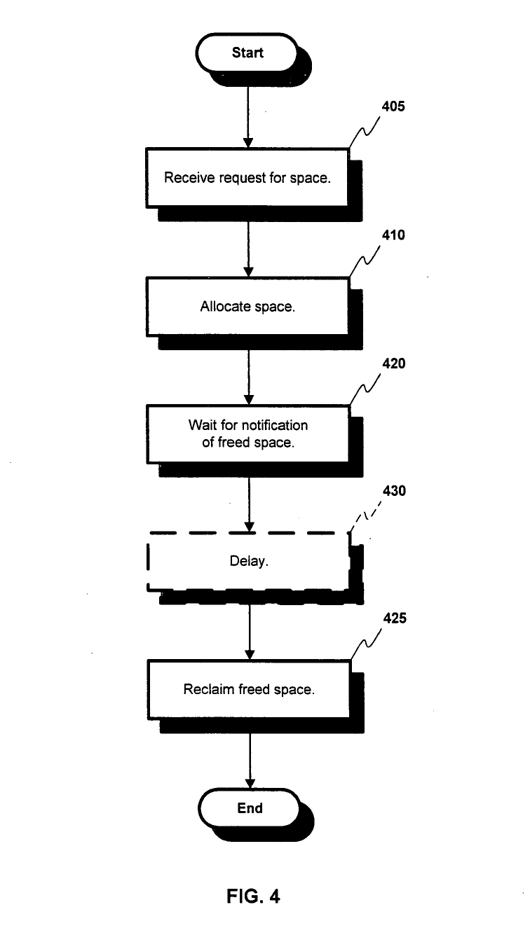

FIG. 4 illustrates the storage-subsystem method 400 of reclaiming freed space. The storage subsystem 22 receives a request for space, 405. The storage subsystem allocates space, but less than requested, 410. The storage subsystem 22 then waits for notification of space freed in the LU 222, step 420. On receipt of notification of freed space, step 430, the storage subsystem 22 reclaims the free space, step 425.

Step 430 indicates a delay of reclamation according to a preferred embodiment. The storage subsystem 22 waits between the receipt of the notification of freed space, step 430, and the reclamation of that space, step 425. This delay helps minimize the chances of the storage subsystem 22 reclaiming space only to have to deliver it again relatively soon after. It also helps minimize the chances of the worst-case scenario: I/O forcing delivery of additional space occurs even as the storage subsystem 22 reclaims space.

The delay also helps minimize the overhead of reclaiming additional freed space. Imagine a system administrator deleting hundreds or even thousands of temp files, with each deletion an independent call to the operating system resulting in an independent notification to the storage subsystem 22. Because the numerous notifications will be received one after the other, the storage subsystem 22 can expend tremendous resources handling the notifications completely in seriatim.

In a preferred embodiment, the storage subsystem 22 receives a notification of freed space, waits some portion of a specific time and then receives another notification of freed space. On the second receipt the storage subsystem 22 saves the details of the earlier and later notifications and resets the delay clock. When the delay clock runs out with no more notifications received, the storage subsystem 22 can process the notification details to determine whether any efficiencies can be wrung from consolidating some of the recovery. For example, where the two notifications apply to adjacent extents of M and N freed blocks, respectively, the storage subsystem 22 can process the notifications as one notification pertaining to an extent of M+N blocks.

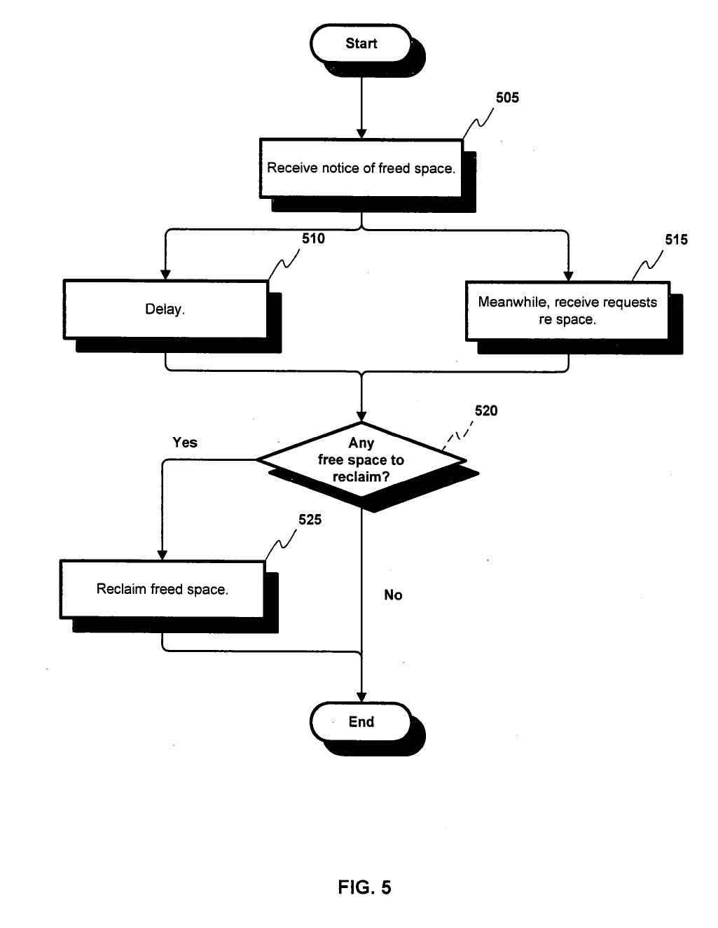

FIG. 5 illustrates the method of delaying the reclamation of freed space. The storage subsystem 22 receives the notice of freed space in LU 222, step 505. The storage subsystem 22 delays a time n, step 510. In the meanwhile, the storage subsystem 22 receives any requests for space regarding the LU 222, step 515. After the delay, the storage subsystem 22 checks whether any of the free space remains to be reclaimed, step 520. If so, the storage subsystem 22 reclaims the free space, step 525.

Of course, the application-level space-freeing event may be the truncation of a file.

In one embodiment, the delay before reclaiming freed space is dependent on the amount of I/O traffic the storage subsystem 22 is experiencing with respect to the LU 222. Where I/O traffic is very light, the delay may be relatively shorter. Where I/O traffic is heavy, the delay may be relatively longer.

This specification incorporates by reference all publications and patent applications mentioned herein, to the same extent if the specification had specifically and individually incorporated by reference each such individual publication or patent application. As this invention may be embodied in several forms without departing from the spirit of essential characteristics thereof, the present embodiment is therefore illustrative and not restrictive. The appended claims rather than the description preceding them define the scope of the invention. Changes that fall within the metes and bounds of the claims, or the equivalence of such metes and bounds thereof are therefore intended to be embraced by the claims.

1. A system, comprising:
a computer which comprises a CPU and a memory; and
a storage subsystem which comprises a pool of storage from which the storage subsystem can allocate a logical unit, wherein the storage subsystem is configured to
receive a request for a space in the pool,
allocate a space from the pool,
wait for a notification of freed space, and
in response to the notification, reclaim the freed space.

2. The system of the claim 1, wherein the computer is configured to delete a file in the logical unit.

3. The system of the claim 2, wherein the computer is further configured to:
recognize deletion of the file as providing a freed space, and
communicate recognition of the freed space to the storage subsystem.

4. The system of the claim 1, further comprising a communication subsystem which couples the computer and the storage subsystem.

5. The system of the claim 1, wherein the memory comprises an application and an operating system.

6. The system of the claim 5, wherein the application is configured to issue a command to delete a file in the logical unit, and the operating system is configured to make a command to delete the file in response to the command from the application.

7. The system of the claim 5, wherein the application is configured to receive an acknowledgement that the space is freed, and communicate the acknowledgement to the operating system.

8. The system of the claim 7, wherein the operating system is further configured to communicate the acknowledgement to the storage subsystem.

9. The system of the claim 1, wherein the storage subsystem is further configured to delay by waiting for a specific time to pass between the notification and reclamation of the freed space.

10. The system of the claim 9, wherein the storage subsystem is further configured to, after the delay, check whether any of the freed space remains to be reclaimed.

11. The system of the claim 10, wherein the storage subsystem is further configured to, if any of the freed space remains to be reclaimed, reclaim the freed space.

12. The system of the claim 1, wherein the space allocated from the pool is less than the space of the request until additional space is available after reclaiming the freed space.

13. A method of reclaiming storage in a system that includes a computer and a storage subsystem having a pool of storage from which the storage subsystem can allocate a logical unit, the method comprising:
receiving by the storage subsystem a request for a space in the pool,
allocating a space from the pool,
waiting for a notification of freed space, and
in response to the notification, reclaiming the freed space.

14. The method of the claim 13, wherein the space allocated from the pool is less than the space of the request until additional space is available after reclaiming the freed space.

15. The method of the claim 13, further comprising deleting a file in the logical unit.

16. The method of the claim 15, further comprising:
recognizing deletion of the file as providing a freed space, and
communicating recognition of the freed space to the storage subsystem.

17. The method of the claim 13, further comprising waiting for a specific time of delay to pass between the notification and reclamation of the freed space.

18. The method of the claim 17, further comprising, after the delay, checking whether any of the freed space remains to be reclaimed.

19. The method of the claim 18, further comprising, if any of the freed space remains to be reclaimed, reclaiming the freed space.
